(19) United States
(12) Patent Application Publication
(10) Pub. No.: US 2026/0208225 A1
(43) Pub. Date: Jul. 23, 2026

(54) CONVEYOR AND HOIST SYSTEM AND METHOD

(71) Applicant: SST Systems, Inc., Sturgeon Bay, WI (US)

(72) Inventors: Robert G. Rock, Sturgeon Bay, WI (US); Chad Martin Andreae, Sturgeon Bay, WI (US)

(21) Appl. No.: 19/452,003

(22) Filed: Jan. 16, 2026

Related U.S. Application Data
(60) Provisional application No. 63/746,887, filed on Jan. 17, 2025.

(51) Int. Cl. B05C 13/00; B65G 13/00; B65G 47/24; B66C 19/00

(52) U.S. Cl. CPC B05C 13/00; B65G 47/24; B66C 19/00; B65G 13/00; B65G 2201/0267

(57) ABSTRACT

A finishing system including a skid to support a workpiece, a first set of work stations arranged along a first work axis to form a first process line, where the first process line is configured to treat the workpiece using a first process style, a first handling system configured to convey the skid along the first work axis, and a second set of work stations arranged along a second work axis to form a second process line, where the second process line is configured to treat the workpiece using a second process style different that the first process style and a second handling system configured to convey the skid along the second work axis. The finishing system also includes a third handling system configured to convey the skid along a third work axis, where the third work axis intersects with both the first work axis and the second work axis.

### RELATED APPLICATIONS

This application claims priority to U.S. Provisional Application No. 63/746,887, filed on Jan. 17, 2025. The entire contents of which is hereby incorporated by reference.

### FIELD

The present device relates to a finishing system and specifically a finishing system that can accommodate multiple process lines having different process styles.

### BACKGROUND

The present devices relates to finishing systems and processes for manufactured parts, and more particularly to conveyors and carriers for transporting manufactured parts through a finishing process

### SUMMARY

In one aspect, a finishing system including a skid configured to support a workpiece, a first set of one or more work stations arranged along a first work axis to form a first process line, where the first process line is configured to treat the workpiece using a first process style, a first handling system configured to convey the skid along the first work axis, a second set of one or more work stations arranged along a second work axis to form a second process line, where the second process line is configured to treat the workpiece using a second process style different that the first process style, a second handling system configured to convey the skid along the second work axis, and a third handling system configured to convey the skid along a third work axis, where the third work axis intersects with both the first work axis and the second work axis.

Alternatively or additionally, in any combination, a first handoff zone where the third work axis intersects the first work axis, and where the skid is exchanged between the first handling system and the third handling system at the first handoff zone, and a second handoff zone where the third work axis intersects the second work axis, and where the skid is exchanged between the second handling system and the third handling system at the second handoff zone.

Alternatively or additionally, in any combination, where the first process style includes sequential processing while the second process style includes batch processing.

Alternatively or additionally, in any combination, where the first process style includes sequential processing while the second process style includes continuous processing.

Alternatively or additionally, in any combination, where the first process style includes unidirectional processing while the second process style includes bi-directional processing.

Alternatively or additionally, in any combination, where the first process style includes sequentially inserting and removing the workpiece from at least a portion of the work stations along the first work axis.

Alternatively or additionally, in any combination, where the first handling system includes a first hoist runway extending along the first work axis and a first hoist movable along the first hoist runway.

Alternatively or additionally, in any combination, where the first hoist is configured to tilt the workpiece carrier relative thereto about at least one degree of freedom.

Alternatively or additionally, in any combination, where the first process line is a coating process line, and where the second process line is a curing process line.

Alternatively or additionally, in any combination, where the workpiece carrier includes a first mounting point and a second mounting point different than the first mounting point, where the first handling system forms a connection with the first mounting point, and where the second handling system forms a connection with the second mounting point.

In another aspect, a finishing system including a skid configured to support a workpiece, a first set of one or more work stations arranged along a first work axis to form a first process line, a first handling system configured to convey the skid along the first work axis, a second set of one or more work stations arranged along a second work axis to form a second process line, a second handling system configured to convey the skid along the second work axis, a third handling system configured to convey the skid along a third work axis, where the third work axis intersects with both the first work axis and the second work axis, and where the first handling system, the second handling system, and the third handling system utilize at least two different handling styles.

Alternatively or additionally, in any combination, where the first handling system conveys the skid using a first handling style and where the second handling system conveys the skid using a second handling style different than the first handling style.

Alternatively or additionally, in any combination, where the first handling style includes an overhead carriage while the second handling style includes an underneath carriage.

Alternatively or additionally, in any combination, where the third handling system conveys the skid using a third handling style different than the first handling style and the second handling style.

Alternatively or additionally, in any combination, where the third handling style includes conveying the skid along a roller conveyor.

Alternatively or additionally, in any combination, where the first handling system conveys the skid using a first handling style and where the third handling system conveys the skid using a second handling style different than the first handling style.

Alternatively or additionally, in any combination, where the first handling style includes an overhead carriage while the second handling style includes a roller conveyor.

In another aspect, a finishing system including a skid configured to support a workpiece, a first set of one or more work stations arranged along a first work axis to form a coating line, a first handling system configured to convey the skid along the first work axis, a second set of one or more work stations arranged along a second work axis to form a curing line, a second handling system configured to convey the skid along the second work axis, a third handling system configured to convey the skid along a third work axis, where the third work axis intersects with both the first work axis and the second work axis.

Alternatively or additionally, in any combination, where the coating line treats the workpiece using a first process style and wherein the curing line treats the workpiece using a second process style different than the first process style.

Alternatively or additionally, in any combination, where the first handling system conveys the skid using a first handling style, and where the second handling system conveys the skid using a second handling style.

### BRIEF DESCRIPTION OF THE DRAWINGS

FIG. 1 is a plan view of the finishing system of the present construction.

FIG. 2 is a detailed plan view of the finishing system of FIG. 1.

FIG. 3 is an elevation view of the finishing system of FIG. 1.

FIG. 4 is a detailed elevation view of the first process line taken from FIG. 3.

FIG. 5 is a detailed elevation view of the second process line taken from FIG. 3.

FIG. 6 is a detailed plan view of a workpiece mounted to a carrier.

FIG. 7 is a side view of a carrier coupled to the first hoist assembly of the first process line with the carrier and associated workpiece overlaid as multiple tilt positions.

FIG. 8 is a detailed elevation view of the carrier and an associated workpiece lowered into a curing oven.

FIG. 9 is a detailed elevation view of the carrier mounted to the second hoist.

FIG. 10 is a detailed elevation view of the carrier mounted to the first hoist, with the carrier and hoist overlaid as multiple tilt positions.

FIG. 11 is a plan view of another embodiment of a finishing system.

FIGS. 12-15 illustrate an embodiment of a handoff zone within the finishing system of FIG. 11.

FIGS. 16-19 illustrate another embodiment of a handoff zone within the finishing system of FIG. 11.

FIG. 20 is a sectional side view of a third process line.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

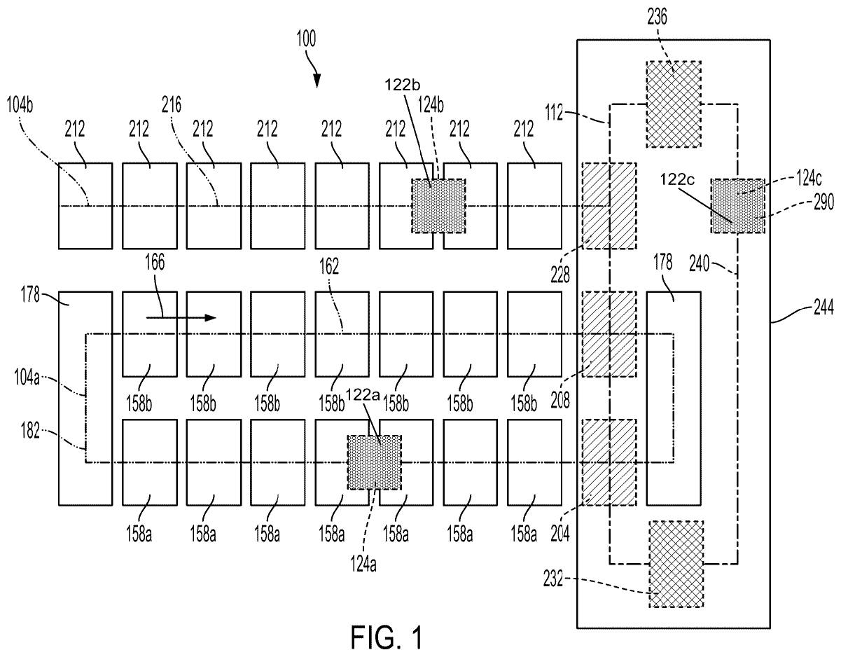

FIGS. 1-3 illustrate a finishing system 100 including a plurality of interconnected process lines 104a, 104b where at least two of the process lines have different workpiece processing styles (e.g., batch processing, sequential processing, unidirectional processing, bi-directional processing, circuit processing, and the like) and/or different workpiece handling styles. The finishing system 100 also includes at least one transfer line 104b in operable communication with each of the process lines 104a, 104b and configured to convey a workpiece or collection of workpieces 108 between the various process lines 104a, 104b.

In some constructions, the finishing system 100 is configured so that a workpiece 108 may be attached or otherwise mounted to a workpiece carrier or skid 110 (discussed below) and passed through multiple process lines 104a, 104b having different processing styles and/or handling styles without having to de-coupled or otherwise re-configured the workpiece 108 with respect to the workpiece carrier 110. In the illustrated construction, the finishing system 100 includes a first process line 104a configured to coat the workpiece 108 using a first processing style (e.g., a sequential unidirectional processing style), and a second process line 104b configured to cure the coating on the workpiece 108 using a second processing style different than the first processing style (e.g., a batch bi-directional processing style).

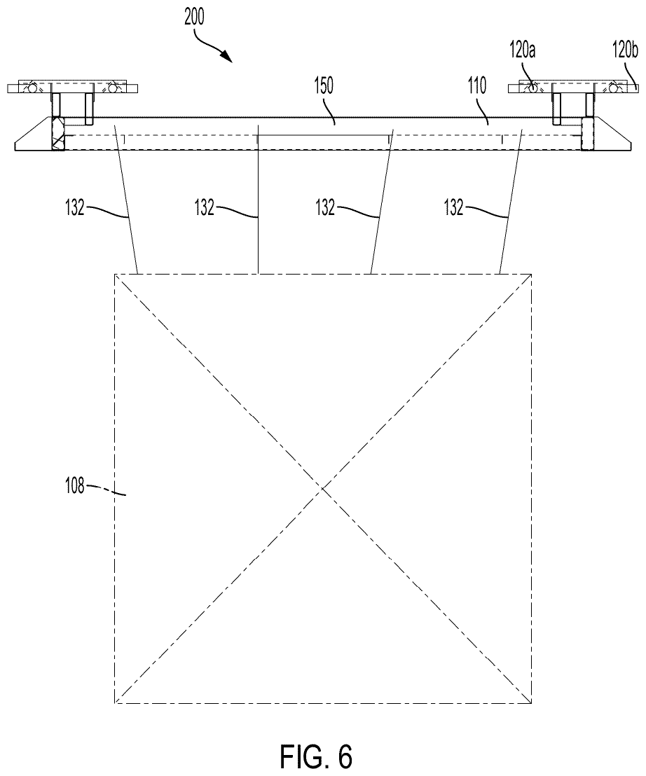

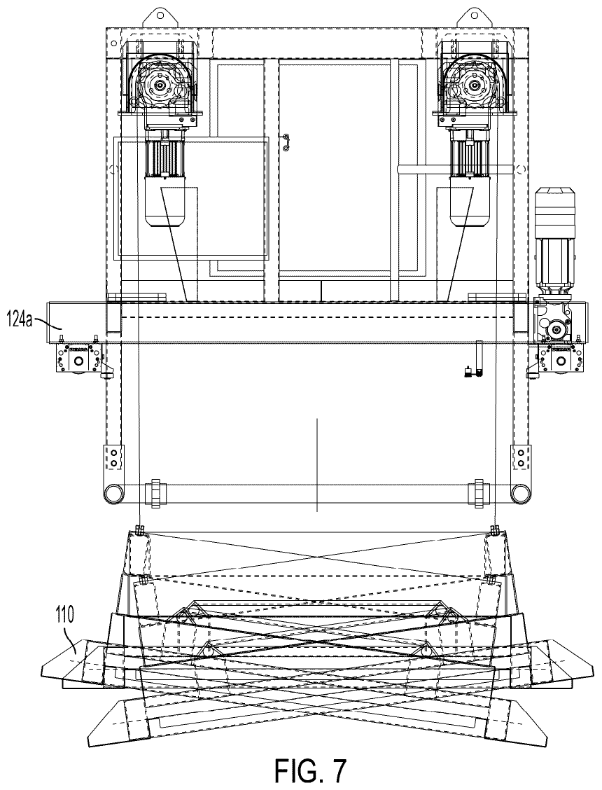

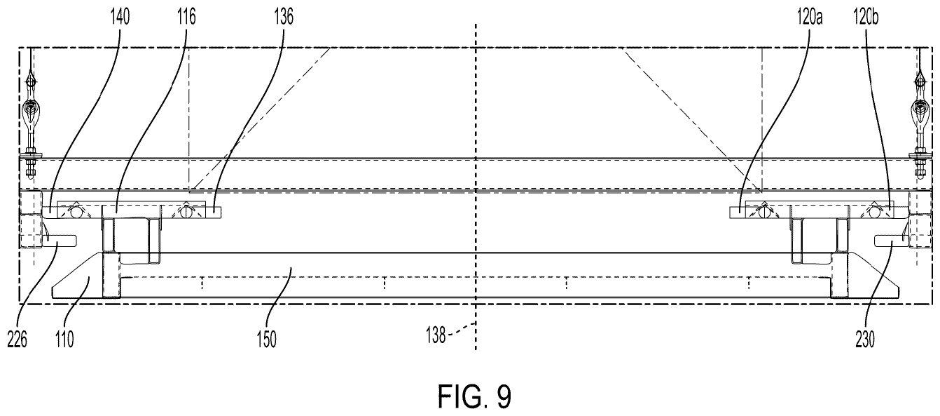

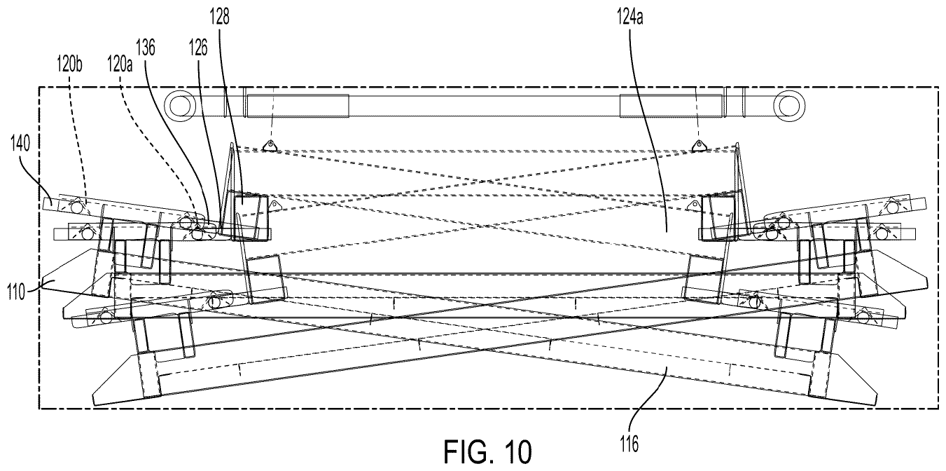

As shown in FIGS. 6, 9 and 10, the workpiece carrier 110 includes a rigid frame or body 116 to which a workpiece or collection of workpieces 108 may be coupled, mounted, and/or positioned during use. In some constructions, the workpiece carrier 110 is configured to accommodate the size and shape of the workpieces 108 making sure that select areas, surfaces, and volumes of the workpieces 108 can be accessed as needed during the finishing process. In the illustrated construction, the workpiece 108 is positioned vertically below the body 116 of the workpiece carrier 110 (e.g., hung) using a series of cables 132. However, in other constructions baskets, racks, brackets, and the like may be used to mount the workpiece(s) 108 to the carrier 110. In still other embodiments, different orientations may be used as well including mounting the workpiece 108 above and to the side of the workpiece 108. The workpiece carrier 110 also includes one or more mounting points 120a, 120b to which the various handling systems 122a, 122b, 122c of lines 104a, 104b, 112, respectively, may attach to the carrier 110. During use, the workpiece carrier 110 serves as an adapter by providing a series of common attachment points to which the handling systems 122a, 122b, 122c of the finishing system 100 (e.g., the hoists 124a, 124b, 124c of the finishing system 100) can couple while accommodating different sizes and types of workpieces 108. In some embodiments, the workpiece carrier 110 may include a plurality of mounting points 120a, 120b, each configured to interact with a corresponding handling system 122a, 122b, 122c of a specific line 104a, 104b, 112. The illustrated workpiece carrier 110 includes a first mounting point 120a configured to form a connection with a hoist 124a of the handling system 122a of the first process line 104a, and a second mounting point 120b different from the first mounting point 120a configured to form a connection with a hoist 124b of the handling system 122b of the second process line 104b (see FIGS. 9 and 10). In the illustrated construction, the second mounting point 120b is also configured to form a connection with a hoist 124c of the handling system 122c of the transfer line 112. In still other embodiments, the carrier 110 may also include a third mounting point (not shown) that is configured to form a connection with the transfer line 112.

In the illustrated construction, the first mounting point 120a includes a first set of pins 136 extending from the frame 116 in an inward direction (e.g., toward from a vertical central axis 138). In that same construction, the second mounting point 120b includes a second set of pins 140 extending from the frame 116 in an outward direction (e.g., away from the central axis 138). As shown in FIGS. 6 and 9, both sets of pins 136, 140 are positioned vertically above the lid 150 (e.g., opposite the workpiece 108) and oriented perpendicular to the vertical central axis 138. Both set of pins 136, 140 are also vertically aligned with each other.

While the illustrated mounting points 120a, 120b include pins 136, 140 extending generally horizontally from the frame 116, it is understood that in other embodiments different forms of connection may also be used. For example, in some embodiments the first mounting point 120a may include a first downwardly open groove formed into the frame 116 while the second mounting point 120b may include a second downwardly open groove positioned inside the first groove. In still other constructions, other forms of passive connections may be used such as, but not limited to, interlocking members, overlapping ledges, tortuous paths, threads, hooks, apertures, keyways, bayonet fittings, and the like. In still other embodiments, active connections may be used such as, but not limited to, actuatable claws, electromagnets, pneumatic cups, and the like.

The illustrated workpiece carrier 110 includes multiple mounting points 120a, 120b to better accommodate the connection and handling requirements of the plurality of processing lines 104a, 104b and transfer lines 112. For example, the first mounting point 120a of the workpiece carrier 110 may emphasize connection strength and connection security to accommodate the lateral forces exerted upon the carrier 110 when the hoist 124a tilts the workpiece 108 during the coating process of the first process line 104a. The first mounting point 120a may also de-emphasize the speed at which the connection can be made and unmade since the carrier 110 remains coupled to the hoist 124a as it travels along the first processing line 104a (e.g., the first mounting point 120a emphasizes connection strength and de-emphasizes coupling and uncoupling speed). Still further, the first mounting point 120a may be positioned and shaped so that it better accommodates the size, shape, and operating style of the work stations 158 associated with the first process line 104a. For example, the overhead of the first mounting point 120a and associated carrier 124a are better suited for open top tanks like those used in coating processes so the connected workpiece 108 may be dipped and then manipulated (e.g., tilted and reoriented).

Alternatively, the second mounting point 120b may not need to accommodate any tilting capabilities 108 but rather may emphasize the ability to couple and decouple quickly and easily as the hoist 124b is required to rapidly attach and detach from multiple carriers 110 during the batch curing process (e.g., the second mounting point 120b emphasizes ease and speed of coupling and uncoupling and de-emphasizes lateral connection strength). Furthermore, the transfer line 112 may also couple to the carrier 110 using the second mounting point 120b as its hoist 124c must also rapidly couple and decouple from multiple carriers 110 during the transfer process. In still other embodiments, the workpiece carrier 110 may include a third mounting point for use with the hoist 124c of the transfer line 112. In still other embodiments, the transfer line 112 may couple to the first mounting point 120a.

In still other embodiments, the carrier 110 may include a single mounting point that accommodates the requirements of both processing lines 104a, 104b. For example, the mounting point may need to be able to accommodate the presence of lateral loads during the tilting process of the first process line 104a and still provide ease of coupling and uncoupling for the batch curing process of the second process line 104b. In still other constructions, different capabilities may also need to be considered to accommodate the conditions of additional process lines such as, but not limited to, temperature, chemical reactivity, electrical conductivity, and the like.

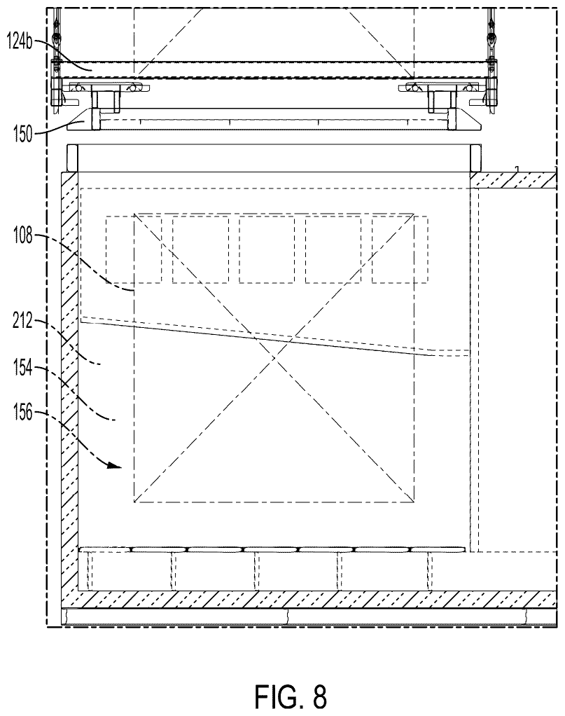

In some constructions, the carrier 110 may also include a lid or panel 150 incorporated into or attached to the body 116. In the illustrated construction, the panel 150 is configured to serve as a lid to seal the curing volume 156 of the curing ovens 154 of the second processing line 104b (see FIG. 8). Specifically, as the workpiece 108 is lowered into a curing oven 154, the lid 150 is positioned such that it will come to rest upon and seal the top of the oven 154 while the workpiece 108 is positioned in the curing volume 156.

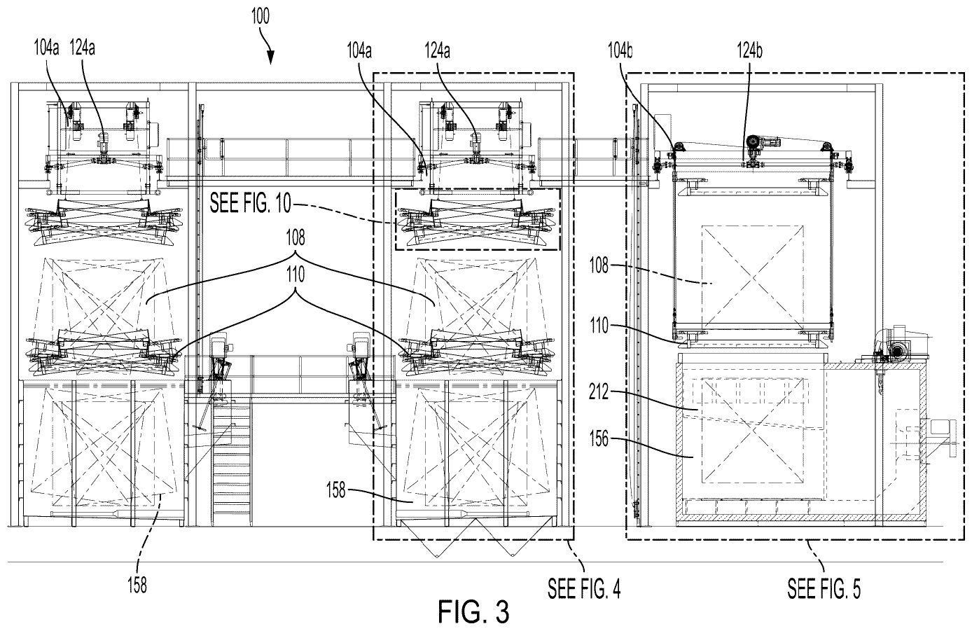

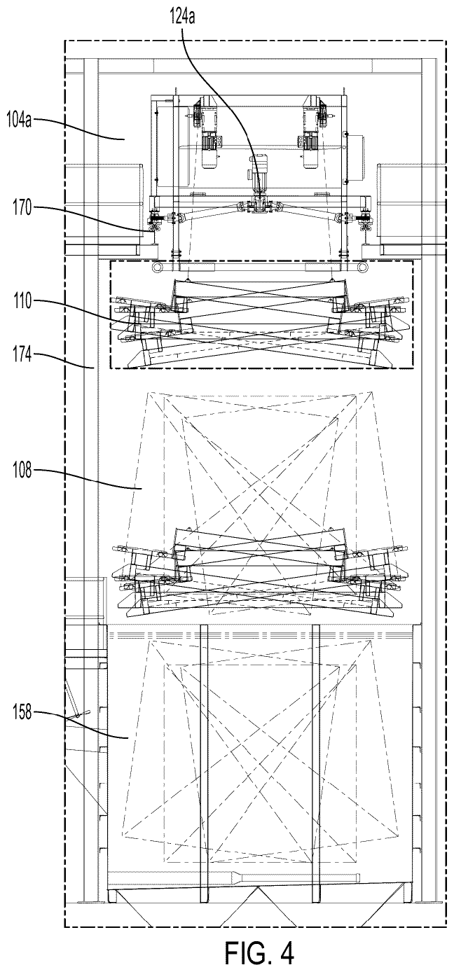

As shown in FIGS. 1-4, the first process line 104a includes a first set of one or more work stations 158 extending along a first work axis 162 as shown in the plan view of FIG. 1. An arrow 166 illustrates the direction of forward travel through the work stations 158. The first process line 104a also includes a first handling system 122a for conveying combined carrier 110 and associated workpieces 108 (e.g., the carrier combination 200) along the first work axis 162 and for interacting with the first set of work stations 158. In the illustrated embodiment, the first handling system 122a includes a first hoist runway 170 extending along the first work axis 162 and positioned vertically above the work stations 158 (see FIG. 3), and a first hoist 124a movable along the first hoist runway 170 to traverse the first plurality of work stations 158.

In some embodiments, the first hoist 124a has the ability to both convey the carrier combination 200 along the first work axis 162 and manipulate the carrier combination 200 with respect to the work stations 158 included in the first process line 104a. The first hoist 124a may also be configured to insert the combinations 200 into the work stations 158, remove the combinations 200 from the work stations 158, and re-orient or tilt the combinations 200 about two or more axis of rotation. In the illustrated embodiment, the first hoist 124a may vertically raise and lower the combination 200 relative to the first hoist runway 170.

In some constructions, some or all of the work stations 158 can include immersion tanks filled with liquid for cleaning, rinsing, and coating the workpiece 108 as it is conveyed through the process line 104a. In other constructions, the first process line 104a can further include additional non-immersion work stations, such as spray stations, heating or oven sections, or inspection stations, among others. In any case, each work station 158 is configured to treat the workpiece 108 in some manner. Additional work stations 158 along the first process line 104a may also be provided for other purposes besides workpiece treatment, e.g., inspection, queueing, workpiece handling, and the like. In some constructions, the work stations 158 of the first process line 104a can include combinations of the following, and in some cases all of the following in sequence: alkaline cleaner immersion, city water rinse, acid clean immersion, neutral rinse, conditioner immersion, zinc phosphate immersion, reverse-osmosis water rinse, electrophoretic deposition (EPD or E-coating), and permeate rinse. Thus, different forms of treatment are performed by the different work stations 158 as part of the first process line 104a to e-coat or electroplate the workpiece 108.

During operation, the carrier combination 200 is conveyed along the first process line 104a via a first hoist 124a. The hoist 124a is movable along the runway 170 formed with one or more rails (e.g., horizontal rails). The runway 170 is supported above the ground by a plurality of support posts 174 that laterally flank the process line 104a. Further, the runway 170 can include fixed and movable rail sections. The hoist 124a is configured for movement (e.g., by an on-board drive, which may include one or more electric motors) along the runway 170 to traverse the work stations 158 of the first process line 104a.

In particular, the hoist 124a conveys the associated workpiece 108, via the carrier 110, along the first work axis 162. The hoist 124a is further configured to raise and lower the workpiece 108, via raising and lowering the carrier 110 suspended therefrom. The hoist 124a may or may not lower and raise the workpiece 108 at each one of the plurality of work stations 158. However, in addition to moving the workpiece 108 between work stations, the hoist 124a operates to lower the workpiece 108 into the liquid bath (when present), and to raise the workpiece 108 out of the liquid bath. The hoist 124a may further operate to tilt or oscillate the workpiece 108 through selective manipulation of separate ends or sides of the carrier 110, such that the workpiece 108 is reoriented from a nominal orientation at least once either in the liquid bath, directly above the liquid bath, or both.

As shown in FIG. 10, the first hoist 124a forms a first connector 126 configured to form a releasable connection with the first mounting point 120a of the carrier 110. As discussed above, the first connector 126 is configured to couple with the first mounting point 120a such that the resulting connection is able to withstand the direction and magnitude of loads produced when tilting the combined carrier 110 and workpiece 108 up to 45 degrees and about up to two axis of rotation. In the illustrated embodiment, the first connector 126 includes a plurality of hooks or grooves 128 formed into the hoist 124a that are sized and shaped to receive a corresponding pin 136 of the first set of pins of the carrier 110.

In some embodiments, the first work axis 162 of the first process line 104a is non-linear and forms a circuit. In such embodiments, the first process line 104a may include a shuttle assembly 178 to convey the carrier 110 (and corresponding workpiece 108) between an upstream sub-group 158a and downstream sub-group of work stations 158b. In the illustrated embodiment, the hoist 124a remains attached to the carrier combination 200 while being conveyed by the shuttle assembly 178. In other embodiments, the shuttle assembly 178 includes a length of shuttle track 182 that is movable between the two sub-groups 158a, 158b and supports the carrier hoist 124a thereon. In still other embodiments, different types of shuttle assemblies may be used to convey the hoist 124a between the upstream and downstream work stations. In still other embodiments, a length of curved runway 170 may be present to accommodate the non-linear work axis 162.

During operation, the first process line 104a processes a given workpiece 108 using a sequential process style. As such, the first process line 104a includes a plurality of hoists 124a each traveling in the same direction about the work axis 162 (see arrow 166). In the illustrated embodiment, each hoist 124a will couple to and remain coupled to a given carrier combination 200 (e.g., a carrier 110 and workpiece 108 coupled together) as it travels over the entire first plurality of work stations 158 (e.g., as the hoist 124a completes one cycle about the first work axis 162).

To process a workpiece 108 using the first process line 104a, the first hoist 124a begins by traveling along the runway 170 until it is positioned within the first handoff zone 204 (discussed in detail below). Once within the first handoff zone 204, the first hoist 124a is configured to couple with the carrier combination 200 positioned therein by joining the first connector 126 with the first mounting point 120a. To do so, the hoist 124a manipulates the connector 126 so that each pin 136 of the first set of pins 136 is positioned within a corresponding groove 128 of the connector 126.

Once coupled together, the first hoist 124a is configured to convey the carrier combination 200 along the first work axis 162 and sequentially interact with select work stations 158 along the way. Specifically, the illustrated hoist 124a is configured interact with tank-style work stations 158 by submerging (e.g., lowering), removing (e.g., raising), and/or tilting the workpiece 108 while remaining coupled thereto. In instances where non-tank-style work stations 158 are present, other forms of interaction may also be used such as positioning or orienting the workpiece 108 in a specific manner for inspection, and the like.

After the hoist 124a has traversed the work stations 158, the hoist 124a and carrier combination 200 will enter the second handoff zone 208. Once positioned within the handoff zone 208, the hoist 124a may place the combination on a support surface (e.g., the floor or on a pallet) and decouple therefrom. In other embodiments, the hoist 124a may directly place the combination 200 on or engage with the transfer line 112 for further processing.

After the hoist 124a is decoupled from the combination 200, it can continue to travel along the first work axis 162 until it re-enters the first handoff zone 204 and can begin the cycle anew.

As shown in FIGS. 1-3, and 5, the second process line 104b includes a second set of one or more work stations 212 extending along a second work axis 216 as shown in the plan view of FIG. 1. The second process line 104b also includes a second handling system 122b for conveying the carrier combination 200 along the second work axis 216 and for interacting with the second set of work stations 212. In the illustrated embodiment, the second handling system 122b includes a second hoist runway 220 extending along the second work axis 216 and positioned vertically above the work stations 212 (see FIG. 3), and a second hoist 124b movable along the second hoist runway 220 to traverse the second plurality of work stations 212.

In some embodiments, the second hoist 124b has the ability to both convey the carrier combination 200 along the second work axis 216 and manipulate the carrier combination 200 with respect to the work stations 212 included in the second process line 104b. The second hoist 124b may also be configured to insert the combinations 200 into the work stations 212, remove the combinations 200 from the work stations 212, and even position a lid 150 to selectively close the work stations 212 (discussed below).

In the illustrated construction, each of the second plurality of work stations 212 are curing ovens configured to receive a recently coated workpiece 108 (e.g., from the first processing line 104a) and treat the workpiece 108 to cure the coating applied thereto. In such constructions, the work stations 212 may heat and/or irradiate the workpiece 108 to cure the coatings applied thereto. In other constructions, other forms of work stations 212 may also be included in the second plurality of work station 212. In the illustrated construction, all the work stations 212 of the second process line 104b are batch-style work stations.

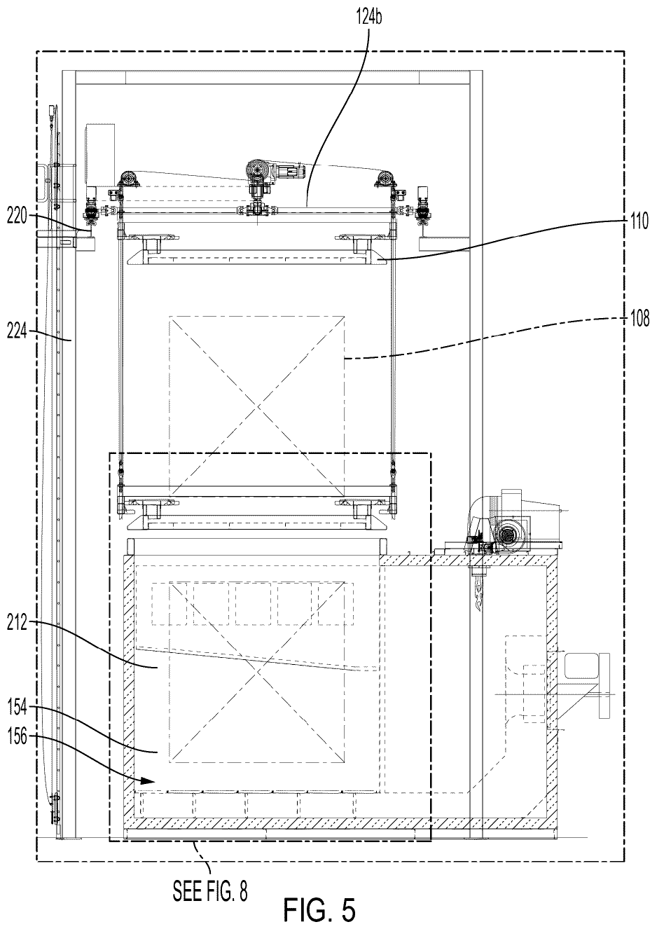

As shown in FIG. 5, the curing oven work stations 212 include a body at least partially enclosing a curing volume 156 therein. Specifically, the top of the curing volume 156 is open so that a workpiece 108 can be vertically lowered into and removed from the curing volume 156 during operation. As discussed above, a lid 150 incorporated into the carrier 110 may be used to cover or enclose the top of the curing volume 156 while the workpiece 108 is positioned therein.

During operation, the combination 200 is conveyed along the second process line 104b via the second hoist 124b. The hoist 124b is movable along the runway 220 formed with one or more rails (e.g., horizontal rails). The runway 220 is supported above the ground by a plurality of support posts 224 that laterally flank the process line 104b. As discussed below, the runway 220 can include fixed and movable rail sections. The hoist 124b is configured for movement (e.g., by an on-board drive, which may include one or more electric motors) along the runway 220 to traverse the work stations 212 of the second process line 104b. Furthermore, the second hoist 124b conveys the associated workpiece 108, via the carrier 110, along the second work axis 216. The hoist 124b is further configured to raise and lower the workpiece 108, via raising and lowering the carrier 110 suspended therefrom.

As shown in FIG. 9, the second hoist 124b forms a second connector 226 different than the first connector 126 that is configured to form a releasable connection with the second mounting point 120b of the carrier 110. As discussed above, the second connector 226 is configured to couple with the first mounting point 120a such that it can quick couple and decouple with the carrier 110. In the illustrated embodiment, the second connector 226 includes a plurality of hooks or grooves 230 formed into the hoist 124b that are sized and shaped to receive a corresponding pin 140 of the second set of pins of the carrier 110.

In the illustrated embodiment, the second work axis 216 of the second process line 104b is linear and supports a batch processing style. As such, the second process line 104b of the illustrated construction has a single hoist 124b that travels back and forth in both directions along the entire length of the second work axis 216. In the illustrated construction, the hoist 124b is configured to temporarily couple with a given carrier combination 200 to either move the combination 200 from the third handoff zone 228 to a select work station 212, from a work station 212 back to the third handoff zone 228, and/or between work stations 212, and then decouple with the combination 200 once in position. The hoist 124b does not remain coupled to the combination 200 as it is processed by a given work station 212.

To process a given carrier combination 200 with the second process line 104b, the second hoist 124b is configured travel along the runway 244 until it is positioned within the third handoff zone 228. Once within the third handoff zone 228, the second hoist 124b is configured to couple with the carrier combination 200 positioned therein by joining the second connector 226 with the second mounting point 120b. To do so, the hoist 124b manipulates the connector 226 so that each pin 140 of the second set of pins 140 is positioned within a corresponding groove 230 of the connector 226.

Once coupled, the second hoist 124b is configured to bring the carrier combination 200 to a select work station 212 and lower the carrier combination 200 into the work station 212 until the workpiece 108 is positioned within the curing volume 156 and the lid 150 encloses the open top thereof. The second hoist 124b then detaches from the carrier combination 200 and proceeds to interact with additional combinations 200. While this is occurring, the workpiece 108 undergoes a curing cycle while remaining positioned in the curing volume 156 of the select work station 212.

After the curing cycle is complete, the second hoist 124b then re-couples to the second mounting point 120b of the carrier combination 200 as discussed above. The second hoist 124b then lifts the combination 200 from the station 212 causing the lid 150 and workpiece 108 to both be removed from engagement with the work station 212. The second hoist 124b then returns the combination 200 to the third handoff zone 228 and decouples therefrom. The second hoist 124b may then continue to service additional combinations 200 within the second process line 104b and in the third handoff zone 228.

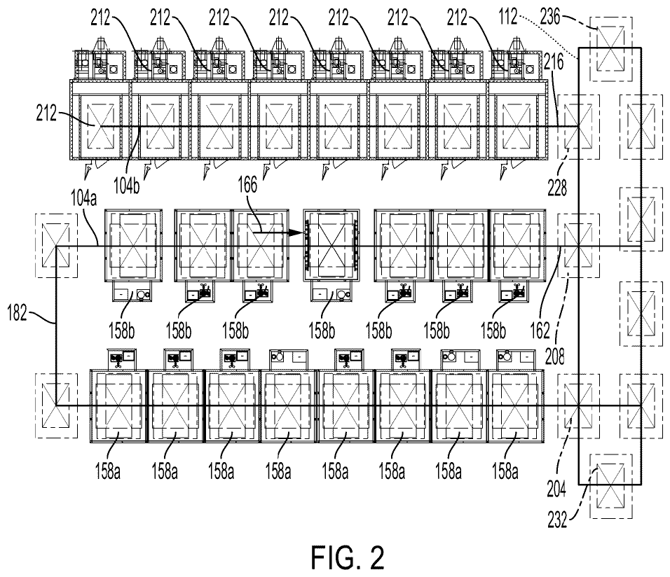

As shown in FIGS. 1 and 2, the transfer line 112 is configured to transfer carrier combinations 200 between the first process line 104a, the second process line 104b, an entry zone 232, and an exit zone 236. The transfer line 112 defines a third work axis 240 that overlaps or intersects both the first work axis 162 and the second axis 216 (e.g., when viewed in from above, see FIG. 1) to form handoff zones 204, 208, 228. The transfer line 112 also includes a third handling system 122c for conveying the carrier combination 200 both along the third work axis 240 and for accommodating the transfer of the combination 200 between itself, the first handling system 122a, and the second handling system 122b.

In the illustrated embodiment, the third handling system 122c includes a third hoist runway 244 and a third hoist 124c movable along the third hoist runway 244. During operation, the carrier 110 is conveyed along the transfer line 112 via the third hoist 124c. The hoist 124c is movable along the third runway 244 formed with one or more rails (e.g., horizontal rails). The third runway 244 is supported above the ground by a plurality of support posts that laterally flank the third work axis 240. Further, the third runway 244 can include fixed and movable rail sections. The illustrated hoist 124c is configured for movement (e.g., by an on-board drive, which may include one or more electric motors) along the runway 244 to traverse between the handoff zones 204, 204, 228, the entry zone 232, and the exit zone 236.

As discussed above, the locations where the transfer line 112 overlaps the first and second work axes 162, 216 form handoff zones 204, 208, 228 where carrier combinations 200 can be handed off or exchanged between being controlled by the third handling system 122c and being controlled by the handling systems 122a, 122b, 122c occupying the corresponding zones (e.g., between the first and third handling systems 122a, 122c in the first and second handoff zones 204, 208 and between the second and third handling system 122b, 122c in the third handoff zone 228). In the illustrated embodiment, the third work axis 240 overlaps the first work axis 162 in two locations producing the first handoff zone 204 upstream of the first plurality of work stations 158 and the second handoff zone 208 downstream of the first plurality of work stations 158. The illustrated third work axis 240 also overlaps the second work axis 216 in one location producing the third handoff zone 228 adjacent the second plurality of work stations 212.

In the illustrated embodiment, the runway 244 of the transfer line 112 is vertically offset from the runways 170, 220 of the first and second process lines 104a, 104b. In some embodiments, the runways 170, 220 are, in turn, positioned at the same first vertical height from the floor while the runway 244 of the transfer line 112 is located at a second vertical height greater than the first vertical height. By doing so, the transfer line 112 is able to operate along the runway 244 without interfering with or having to avoid the operation of the process lines 104a, 104b.

Similar to FIG. 9, the third hoist 124c forms a connector 290 similar to the second connector 226 of the second hoist 124b. As such, the details of the connector 290 will not be described in detail herein. It is understood that in other constructions, a different form of connector 290 may also be present.

In some embodiments, the third work axis 240 of the transfer line 112 is non-linear and forms a circuit. In such embodiments, the transfer line 112 may include a shuttle assembly 178 (described above) or sections of curved runway 170 as needed to accommodate the non-linear form of the work axis 240. In the illustrated embodiment, the hoist 124c remains attached to the carrier combination 200 while being conveyed by the shuttle assembly 178.

During operation, the transfer line 112 includes a plurality of hoists 124c each traveling in the same direction about the third work axis 240 (e.g., clockwise). While traveling along the work axis 240 in a clockwise direction, the order in which the hoists 124c approach the handoff zones 204, 208, 228, the entry zone 232, and exit zone 236 help optimize their operation. Specifically, a given hoist 124c traveling along the illustrated runway 244 will first approach and enter the entry zone 232. Once there, the hoist 124c will couple with a carrier combination 200 if present in a similar manner to which the second hoist 124b couples to carrier 110 (discussed above).

Once coupled, the hoist 124c will continue to travel in a clockwise direction along the runway 244 until it approaches the first handoff zone 204. If the first handoff zone 204 is occupied by another combination 200, the hoist 124c will pause and remain outside the zone until it becomes cleared (e.g., by the first hoist 124a). Once open, the hoist 124c will enter the first handoff zone 204 and decouple with the combination 200, allowing the combination to subsequently be picked-up and processed by the first process line 104a as discussed above.

After dropping off the combination 200, the hoist 124c will continue to travel in a clockwise direction until it approaches the second handoff zone 208. If the zone 208 is unoccupied the hoist 124c will pause and remain outside the zone until a combination 200 is placed therein. Once occupied, the hoist 124c will enter the zone 208 and couple with the combination 200 positioned therein in the same manner discussed above. To note, the combination 200 within the second zone 208 does not necessarily need to be the same combination 200 that was previously dropped off in the first zone 204. Instead, if multiple combinations 200 are circulating through the system 100 at a given time, it is likely the picked-up combination 200 will be a different unit than the one dropped off.

Once coupled, the hoist 124c will continue to travel in a clockwise direction until it approaches the third handoff zone 228. If the third handoff zone 228 is occupied by another combination 200, the hoist 124c will pause and remain outside the zone 228 until it becomes cleared (e.g., by the second hoist 124b). Once open, the hoist 124c will enter the first handoff zone 204 and decouple with the combination 200, allowing the combination 200 to subsequently be picked-up and processed by the second process line 104b as discussed above.

One the dropped combination 200 is picked up and processed by the second process line 104b, the hoist 124c will remain in place or move to a waiting position just outside the third handoff zone 228 until a new combination 200 is positioned in the third zone 228 by the second hoist 124b. Upon arrival of the new combination 200, the hoist 124c will couple with the combination 200 as discussed above. Again, the combination 200 picked-up from the third zone 228 does not necessarily need to be the same combination 200 that had just been dropped off.

Once coupled, the hoist 124c continues to travel in a clockwise direction until it approaches the exit zone 236. If the exit zone 236 is occupied by another combination 200, the hoist 124c will pause and remain outside the zone 236 until it becomes cleared (e.g., by an external device such as a fork lift or crane). Once open, the hoist 124c will enter the exit zone 236 and decouple with the combination 200, allowing the combination 200 to subsequently be picked-up and removed from the assembly 100.

In some embodiments, one or more of the hoists 124a, 124b 124c may include a sensor to help detect one or more attributes of the workpiece 108 attached thereto. For example, the sensors may be configured to detect, but is not limited to, the weight of the workpiece 108, the thickness of particular elements of the workpiece, thickness or thoroughness of the coatings applied to the workpiece, the temperature of the workpiece, and the like. Furthermore, once one or more attributes of the workpiece are detected by the hoists 124a, 124b, 124c, the hoists may convey the information to a centralized controller at which time the controller may change or alter the processes applicable to the specific workpiece. For example, the controller may alter the speed at which the workpiece is progressing through the process lines 104a, 104b, the controller may alter the dwell time the workpiece remains in any one of the work stations 158, 212, and/or alter what work stations 158, 212 are even interacted with. In the illustrated embodiment, the system 100 may alter the oven profile (e.g., the time, temperature, and heat progression profile) within a given curing oven 154 based at least in part on the detected weight of the workpiece 108 being handled for placement therein.

In some constructions, the hoist 124a, 124b, 124c may include a weight sensor configured to calculate the weight of the workpiece 108 attached thereto. To collect such raw data, the hoist 124a, 124b, 124c may include force or load sensor incorporated into the hoist, a torque sensor to detect the torque needed to lift the workpiece 108, and the like. In other embodiments, the sensor may be incorporated into the carrier 110.

In still other embodiments, the hoist 124a, 124b, 124c, carrier 110, and/or other elements of the system 100 may include some form or scanner or reader able to read labels placed on the workpieces 108 or indicia applied thereto. In such embodiments, the labels and indica may be used to, among other things, determine the specific type of workpiece 108 being handled, the desired processes or process specifications to be applied to the workpiece 108, identification information for tracking, and the like.

When determining attributes of the workpiece 108, the controllers of the system 100 may include an algorithm taking into account known factors such as the pre-existing weight of the carrier 110, the model of workpiece 108 being treated, the current operating conditions (e.g., internal temperature, internal humidity, and the like). By doing so, the controllers may also use the raw data (e.g., weight data) to determine more detailed attributes about the workpiece 108. For example, in some instances the controllers may combine the detected weight of a workpiece 108 and the known designs of that particular type of workpiece 108 to calculate the anticipated thickness of the material forming the workpiece in a specific location.

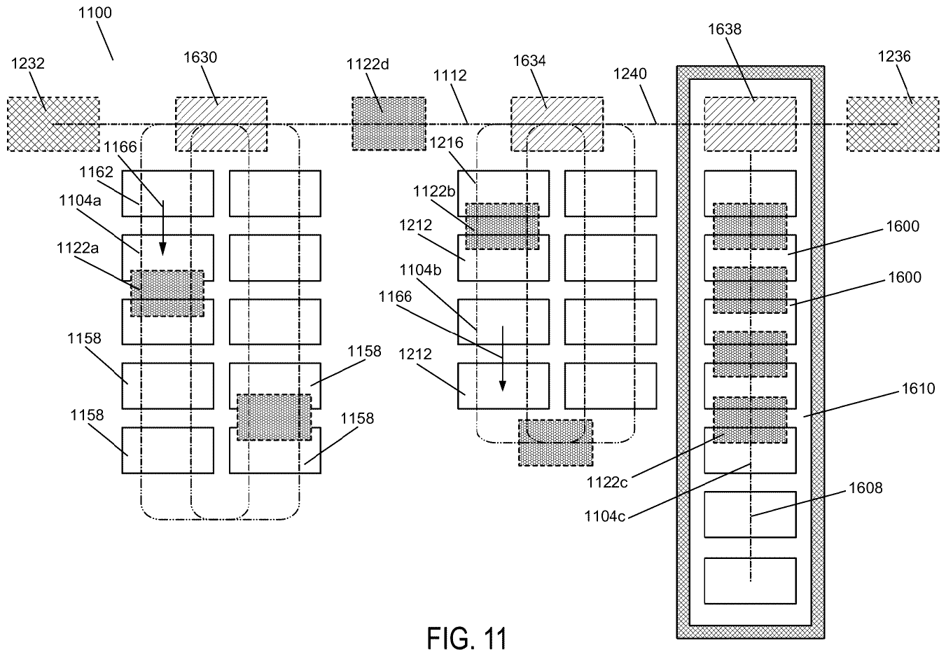

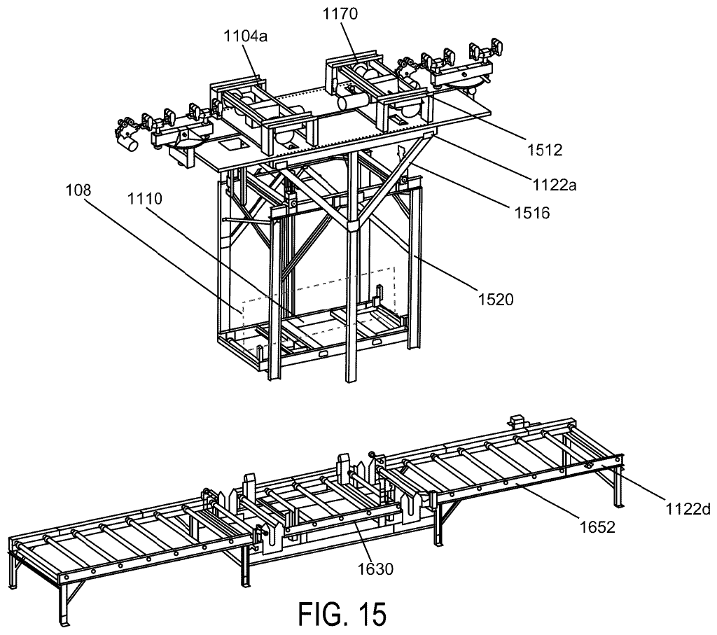

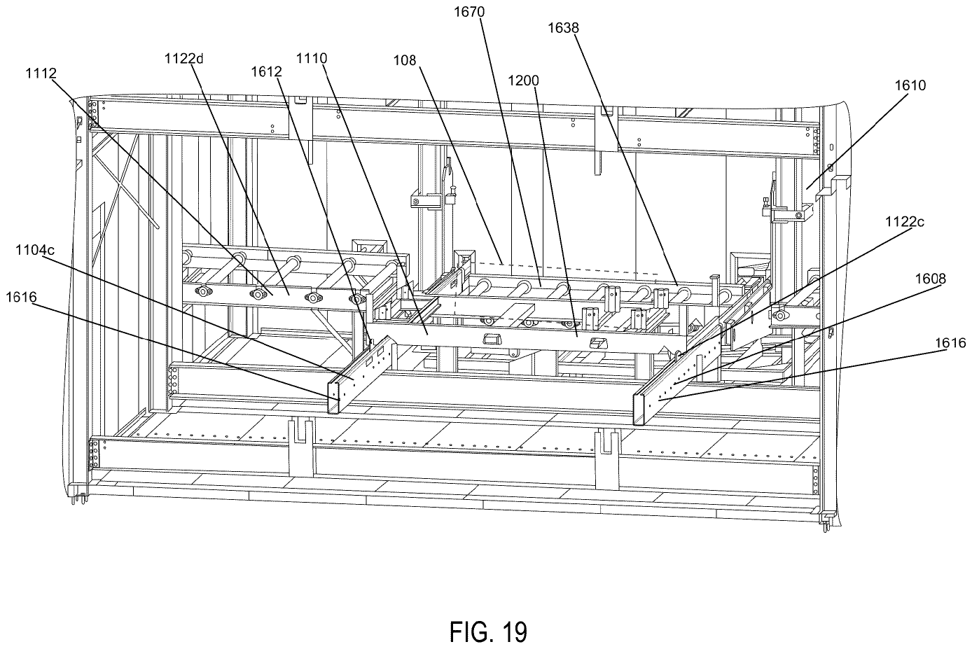

FIGS. 11-20 illustrate another embodiment of a finishing system 1100. The finishing system 1100 is substantially similar to the finishing system 100 described above. As such, only the differences will be described in detail herein.

As shown in FIG. 11, the finishing system 1100 includes a plurality of process lines 1104a-c, and a transfer line 1112 in operable communication with each process line 1104a-c. In some embodiments, the process lines 1104a-c have different workpiece processing styles and/or different workpiece handling styles generally corresponding to the manner in which the workpieces 108 and work stations 1158, 1212, 1600 interact during the finishing process. In the illustrated embodiment, the finishing system 1100 includes a first process or pre-coating line 1104a, a second or coating line 1104b, and a third or curing line 1104c. However, in other embodiments more or fewer process lines may be included.

In some embodiments, the finishing system 1100 is configured so that a workpiece may be attached or otherwise mounted to a skid 1110 (e.g., mounted to the skid 1110, retained in a container formed by the skid 1110, and the like) to form a carrier combination 1200. Once assembled, the finishing system 1100 is configured so that the resulting combination 1200 may be coupled to and maneuvered by each handling system 1122a, 1122b, 1122c, 1122d without having to detach or otherwise disassemble the combination 1200 itself. In the illustrated embodiment, the skid 1110 is configured so that it can be mounted to and/or maneuvered by each handling system 1122a, 1122b, 1122c, 1122d despite at least two of the handling systems 1122a, 1122b, 1122c, 1122d have different workpiece handling styles. Stated differently, the skid 1110 is configured so that the combination 1200 may remain intact throughout a finishing process that includes being coupled to and maneuvered by a first handling system having a first workpiece handling style and a second handling system having a second workpiece handling style different than the first workpiece handling style. In some embodiments, the first handling system and second handling system are associated with the coating and curing processes.

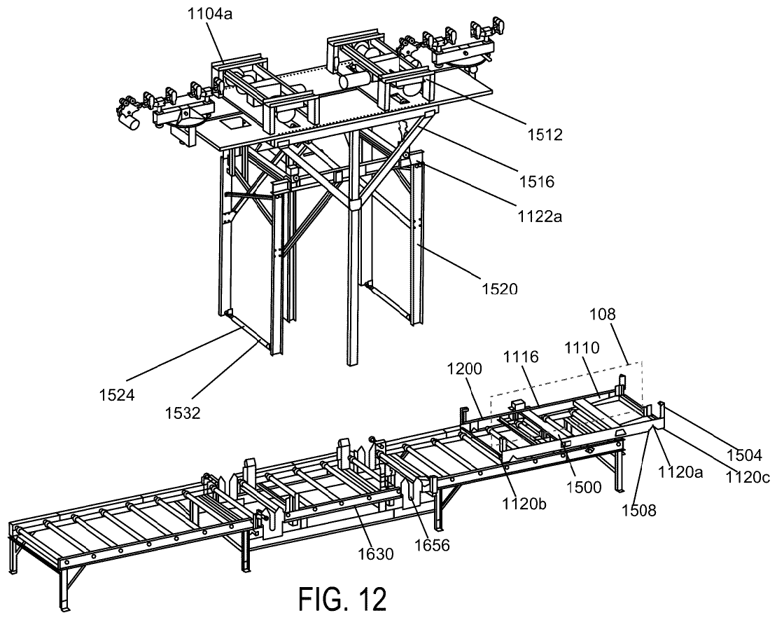

As shown in FIGS. 12-19, the skid 1110 includes a rigid frame or body 1116 to which one or more workpieces 108 may be coupled, mounted, or otherwise positioned during use (discussed above). In the illustrated embodiment, the frame 1116 is substantially rectangular in shape being formed from a plurality of elongated members 1500 welded together to form the final shape. As shown in FIG. 12, the body 1116 may also include one or more brackets, jigs, baskets, and the like 1504 to accommodate the size and shape of the workpiece(s) 108 being mounted thereto.

The skid 1110 also includes a first mounting interface 1120a configured to accommodate the coupling interaction between the skid 1110 and the first handling system 1122a of the first process line 1104a (e.g., a first workpiece handling style). In some embodiments, the first mounting interface 1120a is configured so that the connection formed between the skid 1110 and the first handling system 122a will accommodate vertical, horizontal, and pivoting movement of the combination 1200. In the illustrated embodiment the mounting interface 1120a includes a plurality of recesses or grooves 1508 formed into the underside of the frame 1116. However, in other embodiments different forms of both passive and active connection may be used. In still other embodiments, the first mounting interface 1120a is also configured to accommodate the coupling interaction between the skid 1110 and the second handling system 1122b of the second process line 1104b (e.g., also the first workpiece handling style).

The skid 1110 also includes a second mounting interface 1120b configured to accommodate the coupling interaction between the skid 1110 and the third handling system 1122c of the third process line 1104c (e.g., a second workpiece handling style). In some embodiments, the second mounting interface 1120b is configured so that the connection formed between the skid 1110 and the third handling system 1122c will accommodate both vertical and horizonal movement. In the illustrated embodiment, the second mounting interface 1120b includes a series of bars and recesses formed by and into the underside of the frame 1116 to interface with corresponding elements of the carriages 1612 of the third handling system 1122c. In other embodiments, different forms of both passive and active connection may be used.

The skid 1110 also includes a third mounting interface 1120c configured to accommodate the coupling interaction between the skid 1110 and the fourth handling system 1122c of the transfer line 1112 (e.g., a third workpiece handling style). In the illustrated embodiment, the third mounting interface 1120c includes the overall size and shape of the underside of the frame 1116 which is configured accommodate the size and shape of the rollers of the fourth handling system 1122c.

As shown in FIG. 11, the first process line 1104a includes a first set of one or more work stations 1158 extending along a first work axis 1162. An arrow 1166 indicates the direction of travel through the work stations 1158. In the illustrated embodiment, the first process line 1104a is a pre-coat line configured to treat and otherwise prepare the surfaces of the workpiece(s) 108 for the subsequent coating process.

The first process line 1104a also includes a first handling system 1122a utilizing a first workpiece handling style. In the illustrated embodiment, the first handling system 1122a is an overhead-type system and includes a first hoist runway 1170 extending along the first work axis 1162 and positioned vertically above the work station 1158, a first carriage 1512 configured to travel along the first hoist runway 1170, and a first hoist 1516.

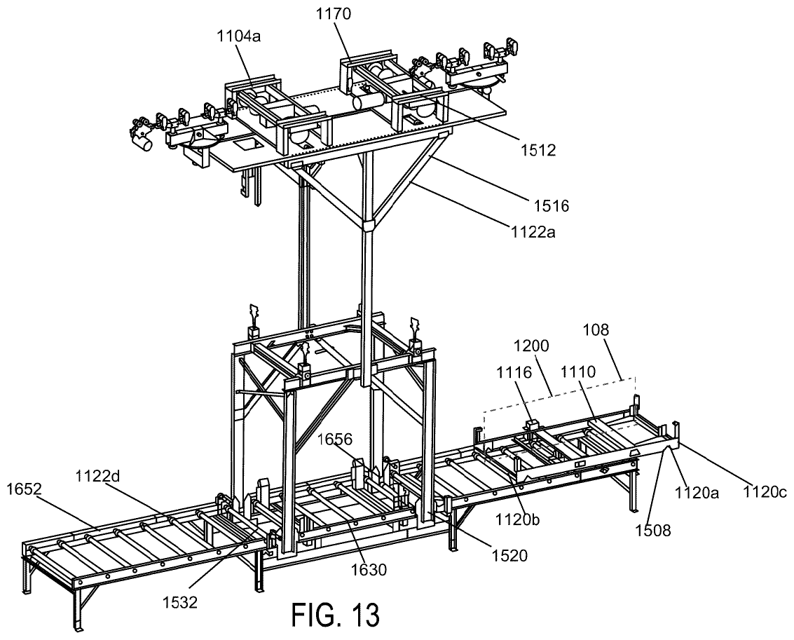

As shown in FIGS. 12 and 13, the first hoist 1516 includes a first hoist subframe 1520. During use, the subframe 1520 is configured to move relative to the carriage 1512. In the illustrated embodiment, the subframe 1520 can move vertically between a first or upper position (see FIG. 12) where the subframe 1520 is proximate the carriage 1512, and a second or lower position (see FIG. 13) where the subframe 1520 is positioned away from the carriage 1512. In some embodiments, the subframe 1520 may also be configured to pivot or tilt relative to the carriage 1512 about one or more axes.

The hoist subframe 1520 includes a connection interface 1524 configured to engage and form a connection with the first mounting interface 1120a of the skid 1110. In the illustrated embodiment, the connection interface 1524 includes a pair of parallel bars 1532 sized, shaped, and positioned to be received within the corresponding grooves 1508 of the skid 1110. While connected, the carriage 1512 is positioned vertically above the skid 1110.

The second process line 1104b includes a second set of one or more work stations 1212 extending along a second work axis 1216. An arrow 1166 indicates the direction of travel through the work stations 1212. In the illustrated embodiment, the second process line 1104b is a coating line configured to apply a coating to various surfaces of the workpiece(s) 108 after being prepared by the first process line 1104a. In some embodiments, the coating process may include an e-coat process, however, in other embodiments different types of coating may also be utilized.

The second process line 1104b also includes a second handling system 1122b utilizing the same first workpiece handling style of the first handling system 1122a. As such, the second handling system 1122b will not be described in detail herein. While the illustrated second process line 1104b utilizes the same first workpiece handing style of the first handling system 1122a, it is understood that in other embodiments a different handling style may be used. Furthermore, in still other embodiments, the first process line 1104a and the second process line 1104b may be combined into a single process line utilizing a common handling system.

The third process line 1104c includes a third set of one or more work stations 1600 extending along a third work axis 1604. An arrow 1166 indicates the direction of travel through the work stations 1600. In the illustrated embodiment, the third process line 1104c is a curing line configured to cure the coating applied by the second process line 1104b.

The third process line 1104c also includes a third handling system 1122c utilizing a second workpiece handling style that is different than the first workpiece handling style. In the illustrated embodiment, the third handling system 1122c is a below-support system and includes a third hoist runway 1608 extending along the third work axis 1604 and positioned vertically below the work stations 1600. The third process line 1104c also includes a third carriage 1612 configured to travel along the third hoist runway 1608 while supporting the skid 1110 on the top thereof. When connected, the third carriage 1612 is positioned below the skid 1110.

The third process line 1104c also includes an oven volume 1610 in which the work stations 1600 are positioned and through which the runway 1608 passes. In the illustrated embodiment, the runway 1608 is a vertical, double-back design where the work axis 1604 travels in a first direction away from the transfer line 1112 on a lower level, and then returns toward the transfer line 1112 on an upper level. In other embodiments, different axis 1604 layouts may be used.

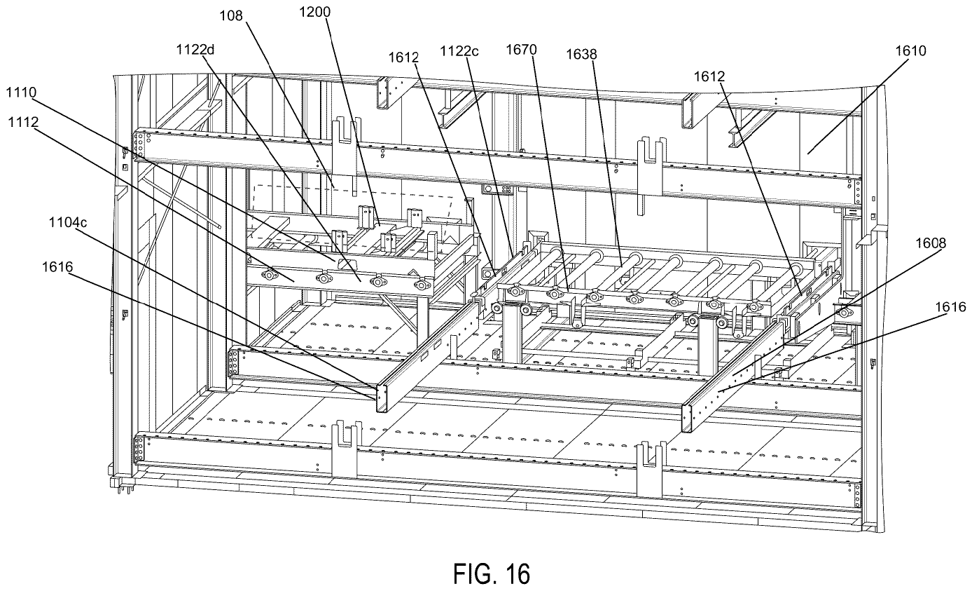

As shown in FIG. 16, the third hoist runway 1608 includes a pair of rails 1616 extending parallel to each other and along the third work axis 1604. Each rail 1616, in turn, supports a corresponding carriage 1612 that is configured to engage and support the skid 1110 from below. During use, the carriages 1612 support the skid 1110 such that the combination 1200 is able to travel along the length of the rails 1616 and along the third work axis 1604.

As shown in FIG. 11, the transfer line 1112 is configured to transfer carrier combinations 1200 between the various process lines 104a, 104b, 104c, an entry zone 1232, and an exit zone 1236. The transfer line 1112 forms a fourth work axis 1240 that overlaps or intersects the work axis of each associated process line 1104a, 1104b, 1104c to form handoff zones 1630, 1634, 1638. In the illustrated embodiment, the transfer line 1112 forms a single handoff zone 1630, 1634, 1638 with each process line 104a, 104b, 104c, but in other embodiments more or fewer handoff zones may be present to accommodate the workpiece processing styles utilized in the finishing system 1100.

The transfer line 1112 also includes a fourth handling system 1122d utilizing a third workpiece handling style that is different than the first workpiece handling style and the second workpiece handling style. During use, the fourth handling system 1122d is configured to convey the carrier combination 1200 both along the fourth work axis 1240 and to accommodate the transfer of the combination 1200 between itself and the first, second, and third handling systems 1122a-c. In the illustrated embodiment, the fourth handling system 1122d includes a fourth runway 1652 extending along the fourth work axis 1240. In the illustrated embodiment, the fourth runway 1652 includes a powered roller conveyor configured to support and convey the combination 1200 (e.g., specifically the skid 1110) thereon.

As shown in FIGS. 12-15, the first handoff zone 1630 is formed by the overlap of the fourth work axis 1240 of the transfer line 1112 and the first work axis 1162 of the first process line 1104a. During use, the first handoff zone 1630 is configured to accommodate the transfer of the combination 1200 between the first handling system 1122a having a first workpiece handing style and the fourth handling system 1122d having a third workpiece handling style without impacting the assembly of the combination 1200 itself.

In the illustrated embodiment, the handoff zone 1630 includes a plurality of recesses 1656 formed into the fourth runway 1652 and sized to allow the bars 1532 of the hoist subframe 1520 to drop below the support plane and permit the skid 1110 to travel over the top thereof.

To transfer the combination 1200 from the transfer line 1112 to the first process line 1104a, the first hoist 1516 must first be placed in the ready position. To do so, the hoist 1516 travels along the first hoist runway 1170 toward the handoff zone 1630. Once in position (see FIG. 112), the subframe 1520 is then lowered from the upper position toward the second position until the bars 1532 are received within the corresponding recesses 1656 of the runway 1170 and positioned below the support plane thereof (see FIG. 13).

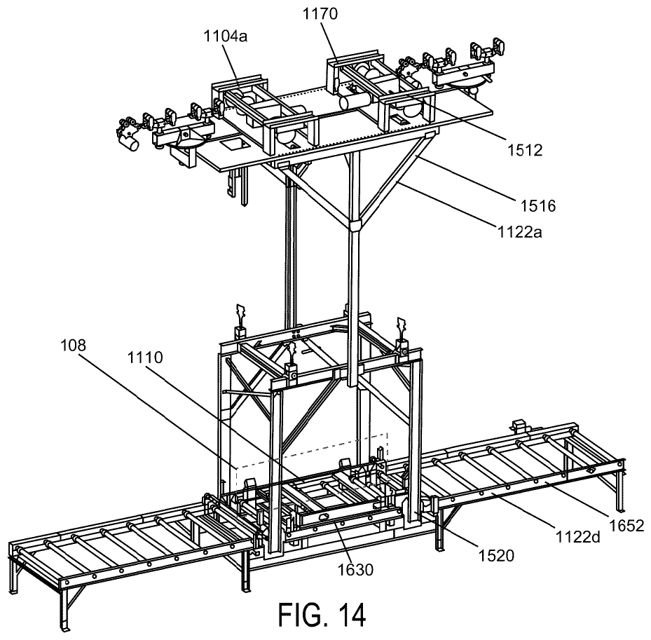

With the hoist 1516 in the ready position (FIG. 13), the skid 1110 (e.g., with workpieces 108 attached thereto) travels along the fourth runway 1652 from the entry zone 1232 and toward the handoff zone 1630. The skid 1110 continues to move along the runway 1652 until the skid 1110 is vertically aligned with the hoist 1516 (see FIG. 14).

Once aligned, the subframe 1520 may then be raised (e.g., into the upper position). By doing so, the bars 1532 are received within the corresponding grooves 1508 of the skid 1110 lifting the combination 1200 out of engagement with the runway 1652 (e.g., the first connection interface 1524 of the subframe 1520 engages the first mounting interface 1120a of the skid 1110).

Once the skid 1110 is fully supported by the subframe 1520, the first handling system 1122a may then convey the carrier combination 1200 along the first work axis 1162 and sequentially interact with select work stations 1158 along the way. Specifically, the illustrated hoist 1516 is configured interact with tank-style work stations 1158 by submerging (e.g., lowering), removing (e.g., raising), and/or tilting the combination 1200 while remaining coupled thereto. In instances where non-tank-style work stations 1158 are present, other forms of interaction may also be used such as positioning or orienting the combination 1200 in a specific manner for inspection, and the like.

After the combination 1200 has traversed the work stations 1158, the hoist 1516 and carrier combination 1200 re-enter the first handoff zone 1630. Once positioned within the first handoff zone 1630, the subframe 1520 will then lower the combination 1200 back onto the fourth runway 1652 (e.g., with the bars 1532 re-entering the recesses 1656 and disengaging from the grooves 1508 of the skid 1110). Once the runway 1652 is fully supporting the weight of the combination 1200, the fourth handling system 1122d may then resume maneuvering the combination 1200 (e.g., traveling toward the second handoff zone 1634).

The second handoff zone 1634 is substantially similar to the first handoff zone 1630 and therefore will be described in detail herein. After the combination 1200 has traversed the second process line 1104b and returned to the second handoff zone 1634, the fourth handling system 122d may then resume maneuvering the combination 1200 (e.g., toward the third handoff zone 1638).

As shown in FIGS. 16-20, the third handoff zone 1638 is formed at the overlap of the fourth work axis 1240 of the transfer line 1112 and the third work axis 1216 of the third process line 1104c. During use, the third handoff zone 1638 is configured to accommodate the transfer of the combination 1200 between the third handling system 1122c having a second workpiece handing style and the fourth handling system 1122d having a third workpiece handling style without impacting the assembly of the combination 1200 itself.

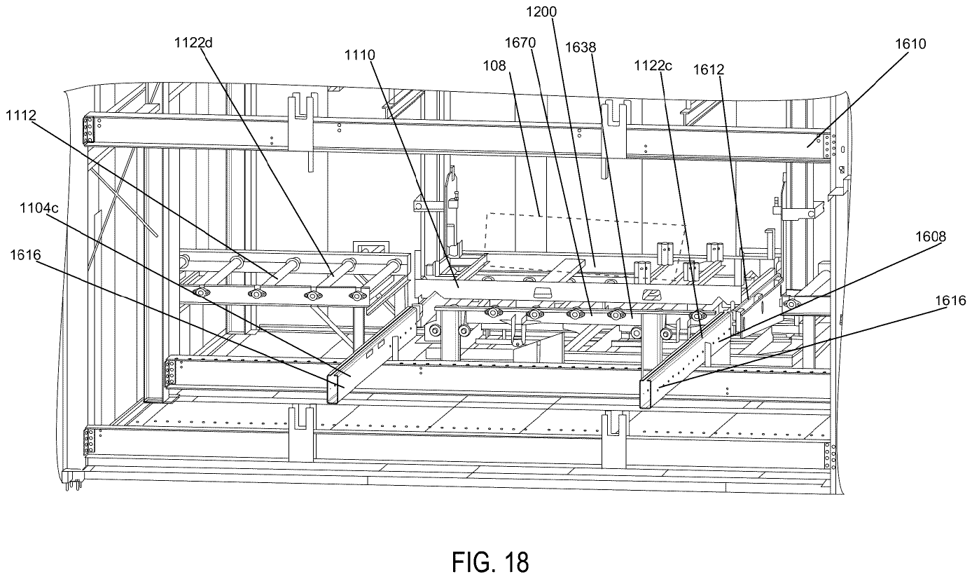

In the illustrated embodiment, the third handoff zone 1638 includes a platform 1670 formed into the fourth runway 1652 and configured to raise and lower the combination 1200 relative to the rails 1616 of the third hoist runway 1608. More specifically, the platform 1670 is movable vertically between a first position (see FIG. 16), in which the platform 1670 is substantially aligned with the fourth runway 1652 (e.g., positioned above the rails 1616 of the third hoist runways 1608), and a second position (see FIG. 18), in which the platform 1670 is substantially aligned with or positioned below the rails 1616 of the third hoist runway 1608.

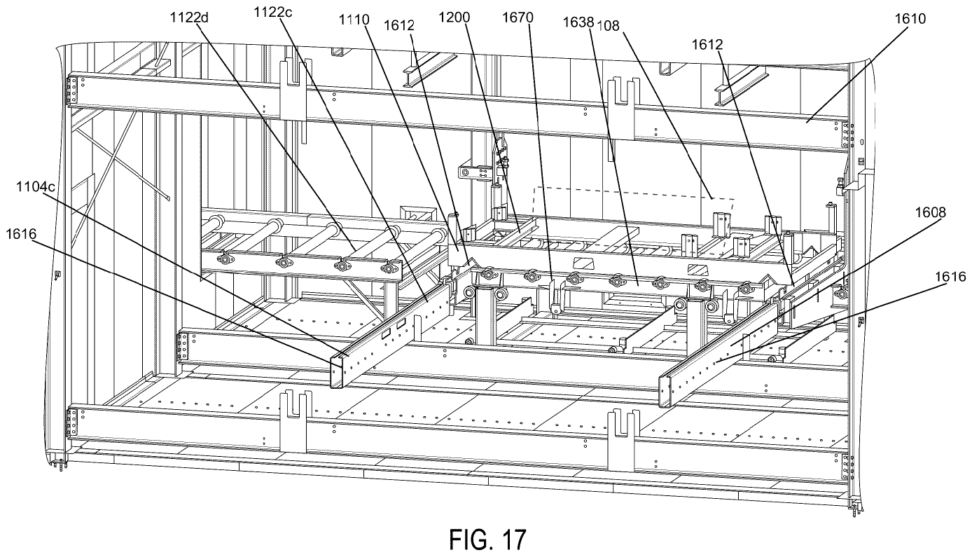

To transfer the combination 1200 from the transfer line 1112 to the third process line 1104c, the platform 1670 begins in the first position. With the platform in the ready position (FIG. 16), the skid 1110 (e.g., with workpieces 108 attached thereto) travels along the fourth runway 1652 from the second handoff zone 1634 and toward and into the third handoff zone 1638. The combination 1200 continues to travel along the fourth runway 1652 until the skid 1110 is positioned atop and supported by the platform 1670 (see FIG. 17).

With the skid 1110 in position, the platform 1670 then moves from the first position toward the second position. While doing so, the skid 1110 is lowered onto and into engagement with the carriages 1612 of the third hoist runway 1608 until the entire weight of the combination 1200 is supported thereon. While doing so, the carriage 1612 align with and engage the second mounting interface 1120b of the skid 1110.

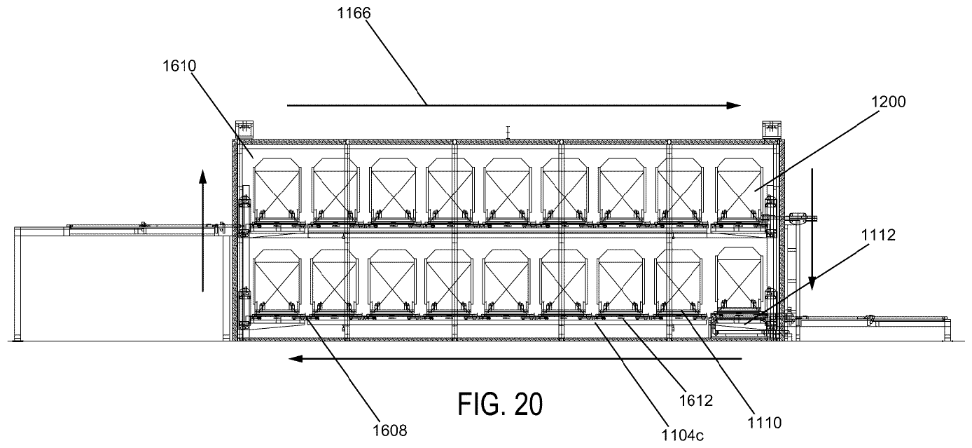

Once the skid 1110 is fully supported by the carriage 1612, the third handling system 1122c may then convey the carrier combination 1200 along the third work axis 1604 (e.g., being biased by a horizontally oriented hydraulic actuator; see FIG. 20). In the illustrated embodiment, the third work axis 1604 extends through the oven volume 1610 whereby the heat therein will cure the coatings applied to the workpieces 108.

After traversing the length of the third work axis 1604, the combination 1200 returns to the third handoff zone 1638. After the combination 1200 is within the zone 1638 (e.g., aligned with the platform 1670), the platform 1670 may then move from the second position back to the first position lifting the skid 1110 off the carriages 1612 and back into alignment with the fourth runway 1652. Once the entire weight of the combination 1200 is supported by the platform 1670, the fourth handling system 1122d can resume maneuvering the combination 1200 along the fourth runway 1652 (e.g., toward the exit zone 1236).

To coat a workpiece or group of workpieces 108, the user first mounts or otherwise combines the workpieces 108 with a corresponding skid 1110 to form a carriage combination 1200. Once formed, the carriage combination 1200 is placed within the entry zone 1232 of the transfer line 1112. To do so, the skid 1110 is positioned atop the rollers of the fourth carriage runway 1652 by an external device (e.g., manually, via a crane, via a forklift, and the like). After the skid 1110 is positioned on the runway 1652, the fourth handling system 1122d of the transfer line 1112 may begin maneuvering the combination 1200 by allowing it to roll along the powered rollers of the runway 1652 (e.g., using the third workpiece handling style).

After leaving the entry zone 1232, the combination 1200 is then directed to the first handoff zone 1630. Upon entering the zone 1630, the combination 1200 is transitioned to the control of the first handling system 1122a as discussed above without having to alter the combination 1200.

After the transition, the combination 1200 is then conveyed through the first pre-coating line 1104a (e.g., along the first work axis 1162) whereby the exterior surfaces of the corresponding workpieces 108 are cleaned and prepared. The combination then returns to the first handoff zone 1630 where the combination 1200 transitions back to the control of the fourth handling system 1122d (discussed above).

After leaving the first handoff zone 1630, the combination 1200 is directed to the second handoff zone 1634. Upon entering the zone 1634, the combination 1200 transitions to the control of the second handling system 1122b, as discussed above, without having to alter the combination 1200.

After the transition, the combination 1200 is conveyed through the second coating line 1104b (e.g., along the second work axis 1216) whereby the exterior surfaces of the corresponding workpieces 108 coated. The combination then returns to the second handoff zone 1634 where the combination 1200 transitions back to the control of the fourth handling system 1122d (discussed above).

After leaving the second handoff zone 1634, the combination 1200 is directed to the third handoff zone 1638. Upon entering the zone 1638, the combination 1200 transitions to the control of the third handling system 1122c, as discussed above, without having to alter the combination 1200.

After the transition, the combination 1200 is conveyed through the third curing line 1104c (e.g., along the third work axis 1604) whereby the applied coatings are cured within the oven volume 1610. The combination 1200 then returns to the third handoff zone 1638 where the combination 1200 transitions back to the control of the fourth handling system 1122d (discussed above).

After leaving the third handoff zone 1638, the combination 1200 is directed to the exit zone 1236 where the finished product can be removed and shipped to a final destination.

What is claimed is:

1. A finishing system comprising:
a skid configured to support a workpiece;
a first set of one or more work stations arranged along a first work axis to form a first process line, wherein the first process line is configured to treat the workpiece using a first process style;
a first handling system configured to convey the skid along the first work axis;
a second set of one or more work stations arranged along a second work axis to form a second process line, wherein the second process line is configured to treat the workpiece using a second process style different that the first process style;
a second handling system configured to convey the skid along the second work axis; and
a third handling system configured to convey the skid along a third work axis, wherein the third work axis intersects with both the first work axis and the second work axis.

2. The finishing system of claim 1, further comprising:
a first handoff zone where the third work axis intersects the first work axis, and wherein the skid is exchanged between the first handling system and the third handling system at the first handoff zone; and
a second handoff zone where the third work axis intersects the second work axis, and wherein the skid is exchanged between the second handling system and the third handling system at the second handoff zone.

3. The finishing system of claim 1, wherein the first process style includes sequential processing while the second process style includes batch processing.

4. The finishing system of claim 1, wherein the first process style includes sequential processing while the second process style includes continuous processing.

5. The finishing system of claim 1, wherein the first process style includes unidirectional processing while the second process style includes bi-directional processing.

6. The finishing system of claim 1, wherein the first process style includes sequentially inserting and removing the workpiece from at least a portion of the work stations along the first work axis.

7. The finishing system of claim 1, wherein the first handling system includes a first hoist runway extending along the first work axis and a first hoist movable along the first hoist runway.

8. The finishing system of claim 7, wherein the first hoist is configured to tilt the skid relative thereto about at least one degree of freedom.

9. The finishing system of claim 1, wherein the first process line is a coating process line, and wherein the second process line is a curing process line.

10. The finishing system of claim 1, wherein the skid includes a first mounting point and a second mounting point different than the first mounting point, wherein the first handling system forms a connection with the first mounting point, and wherein the second handling system forms a connection with the second mounting point.

11. A finishing system comprising:
a skid configured to support a workpiece;
a first set of one or more work stations arranged along a first work axis to form a first process line;
a first handling system configured to convey the skid along the first work axis;
a second set of one or more work stations arranged along a second work axis to form a second process line;
a second handling system configured to convey the skid along the second work axis;
a third handling system configured to convey the skid along a third work axis, wherein the third work axis intersects with both the first work axis and the second work axis; and
wherein the first handling system, the second handling system, and the third handling system utilize at least two different handling styles.

12. The finishing system of claim 11, wherein the first handling system conveys the skid using a first handling style and wherein the second handling system conveys the skid using a second handling style different than the first handling style.

13. The finishing system of claim 12, wherein the first handling style includes an overhead carriage while the second handling style includes an underneath carriage.

14. The finishing system of claim 12, wherein the third handling system conveys the skid using a third handling style different than the first handling style and the second handling style.

15. The finishing system of claim 14, wherein the third handling style includes conveying the skid along a roller conveyor.

16. The finishing system of claim 11, wherein the first handling system conveys the skid using a first handling style and wherein the third handling system conveys the skid using a second handling style different than the first handling style.

17. The finishing system of claim 16, wherein the first handling style includes an overhead carriage while the second handling style includes a roller conveyor.

18. A finishing system comprising:
a skid configured to support a workpiece;
a first set of one or more work stations arranged along a first work axis to form a coating line;
a first handling system configured to convey the skid along the first work axis;
a second set of one or more work stations arranged along a second work axis to form a curing line;
a second handling system configured to convey the skid along the second work axis;
a third handling system configured to convey the skid along a third work axis, wherein the third work axis intersects with both the first work axis and the second work axis.

19. The finishing system of claim 18, wherein the coating line treats the workpiece using a first process style and wherein the curing line treats the workpiece using a second process style different than the first process style.

20. The finishing system of claim 18, wherein the first handling system conveys the skid using a first handling style, and wherein the second handling system conveys the skid using a second handling style.
